(19) United States
(12) Patent Application Publication
(10) Pub. No.: US 2025/0368504 A1
(43) Pub. Date: Dec. 4, 2025

(54) PROCESSES USING SPLIT HYDROCARBON PROCESSING (SHCP) FOR HYDROGEN PRODUCTION AND CARBON DIOXIDE CAPTURE

(71) Applicant: HIS MAJESTY THE KING IN RIGHT OF CANADA, AS REPRESENTED BY THE MINISTER OF NATURAL RESOURCES, Ottawa (CA)

(72) Inventors: Lijun Wu, Ottawa (CA); Bruce Clements, Ottawa (CA); Ted Herage, Stittsville (CA); Mohammad Asiri, McNab/Braeside (CA); Ligang Zheng, Kanata (CA)

(21) Appl. No.: 19/223,257

(22) Filed: May 30, 2025

Related U.S. Application Data
(60) Provisional application No. 63/653,422, filed on May 30, 2024.

(51) Int. Cl. C01B 3/24; B01D 53/047; B01D 53/14; B01D 53/26; C01B 3/14; C01B 3/56; C01B 32/50; C04B 7/43; E21B 43/24; F01D 15/10; F01K 23/10

(52) U.S. Cl. CPC C01B 3/24; B01D 53/047; B01D 53/1475; B01D 53/265; C01B 3/14; C01B 3/56; C01B 32/50; C04B 7/434; F01D 15/10; F01K 23/10; B01D 2256/22; B01D 2257/502; B01D 2257/504; B01D 2257/80; C01B 2203/0272; C01B 2203/0283; C01B 2203/042; C01B 2203/047; C01B 2203/0475; C01B 2203/1241; C01B 2203/84; C01B 2203/86; E21B 43/2406

(57) ABSTRACT

The present invention discloses various applications of split hydrocarbon processing (SHCP) across an array of technologies for hydrogen (H₂), power and industrial production purposes. These applications generate nearly pure carbon dioxide CO₂ with no need for separation, making it ready for compression and storage or utilization.

### FIELD OF THE INVENTION

Split hydrocarbon processing (SHCP) refers to the decomposition of the carbon and hydrogen components within hydrocarbon fuels into two streams: hydrogen (H₂) and solid carbon C (or carbon black C), and these resultant energy products—hydrogen (H₂) and solid carbon C (or carbon black C)—are subsequently utilized in diverse production processes. The present invention discloses various applications of split hydrocarbon processing (SHCP) across an array of technologies for hydrogen (H₂), power and industrial production purposes. These applications generate nearly pure carbon dioxide CO₂ with no need for separation, making it ready for compression and storage or utilization.

### BACKGROUND OF THE INVENTION

Combustion of hydrocarbon fuels is a fundamental energy utilization mechanism and is used throughout various sectors. A major drawback is that green house gas (GHG) emissions from the combustion of hydrocarbon fuels lead to global warming, which is an increasingly dire problem the world faces.

As a result, both CO₂ capture and storage (CCS) technology and hydrogen technology are considered as alternative routes to attain clean energy solutions. These processes however have been traditionally inefficient and expensive and there is a little sign of improving.

As nations grapple with CCS and hydrogen solutions, they are faced with a lack of competitive and feasible technologies.

The first step of a CO₂ capture and storage solution is CO₂ capture, whereby CO₂ is separated from process exhaust gas. The diverse compositions and properties of exhaust gases, resulted from various different production processes, make this CO₂ capture step complex. As s result, no single CO₂ capture technology works effectively across all the scenarios.

There are three major pathways towards CO₂ capture from the oxidation/combustion of hydrocarbon fuels.

### 1. Combustion in Air: Post-Combustion CO₂ Capture (PCC)

Generally, the chemical reaction for stoichiometric combustion of hydrocarbon in the presence of air is as follows:

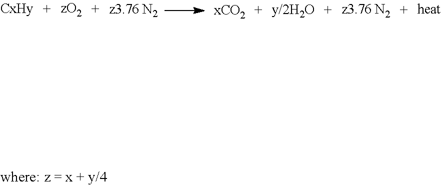

The release of CO₂ is a direct function of the carbon (C) amount in the hydrocarbon, plus moisture H₂O that is a direct function of the hydrogen amount in the hydrocarbon. Air is composed of 21% O₂ and 79% N₂; there are 3.76 moles of N₂ released with CO₂ for every mole of O₂.

An example is the combustion of CH₄:

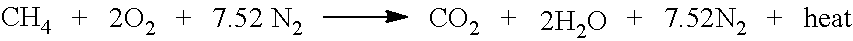

Another example is the combustion of solid carbon C:

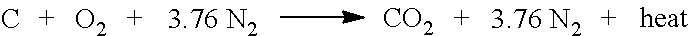

CO₂ capture from the combustion of hydrocarbon in air involves a process of separating CO₂ from the flue gas containing nitrogen and moisture that are released with it. The main technology currently used is amine-based CO₂ capture.

### 2. Gasification in Oxygen: Pre-Combustion CO₂ Capture

In gasification processes, a fuel feedstock is partially oxidized in steam and oxygen under high temperature and pressure to form syngas. This syngas is a H₂ and CO-rich gas mixture with CO₂, and smaller amounts of other gaseous components, such as methane. The syngas can then undergo water-gas shift reaction to convert CO and water (H₂O) to H₂ and CO₂, producing a CO₂and H₂-rich gas mixture. The CO₂ can then be separated and captured from the H₂-rich fuel gas before combustion.

An example would be the gasification of solid carbon C:

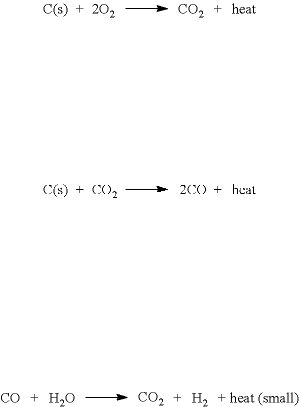

This process also facilitates hydrogen production from solid fuels such as coal and biomass. Gasification can be carried out under high pressure, enabling easier removal of CO₂ from the H₂-rich gas.

### 3. Combustion in Oxygen: Oxy-Fired Combustion CO₂ Capture

The combustion of hydrocarbon fuels in oxygen is the same as in the air, except there is no dilution effect of N₂. To achieve this oxygen-enriched environment, oxygen is pre-separated from nitrogen using an air separation unit (ASU), albeit at the cost of consuming energy. Combustion in oxygen, also known as oxy-fired combustion, will increase flame temperatures, potentially requiring moderation with water, steam or recycled CO₂ usually.

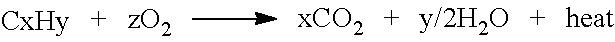

Therefore, the release of CO₂ from oxy-fired combustion is a direct function of the carbon amount in the hydrocarbon, plus moisture H₂O that is a direct function of the hydrogen amount in the hydrocarbon.

Examples would be the oxy-fired combustion of CH₄ and solid carbon C as shown below:

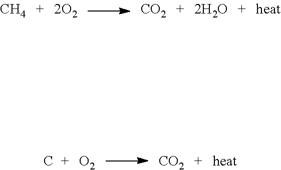

CO₂ capture from oxy-fired combustion of CH₄ involves separating CO₂ from the moisture released during combustion. This is typically achieved through a condensing process, where the moisture is condensed and removed from the flue gas stream, achieving a stream containing more than 97% of CO₂. The CO₂ capture from the oxy-fired combustion of solid carbon C will depend on the conveying mediums that transport bulk solid carbon C into the combustion process. Both water and liquefied CO₂ can be used. With water, the CO₂ stream needs to be separated from the moisture. With liquefied CO₂, a nearly pure CO₂ stream can be achieved.

For post-combustion CO₂ capture based on combustion in air, amine-based technologies, which have been developed and widely used in the hydrocarbon processing industries to capture sour gases including CO₂, are currently representing the most mature means of CO₂ capture. The application of amine-based CO₂ capture for other industries, such as power plants, has dominated R&D in recent years. There are, however, many technical challenges that need to be overcome before these technologies can be industrialized.

One of the major challenges to amine scrubbing for CO₂ capture is the high energy demand required for solvent regeneration. Other challenges, such as the formation of nitrosamines and amine loss, also need to be addressed because they increase the cost of CO₂ capture and pose serious health hazards.

Gasification in oxygen and combustion in oxygen for CO₂ capture require the oxygen being pre-separated from nitrogen with an air separation unit (ASU). Compared to air-fired post-combustion CO₂ capture, oxy-fired CO₂ capture is less costly, to the extent that the total investment of post-combustion CO₂ capture is approximately 1.6 times higher than the oxy-fired CO₂ capture process. The R&D of oxy-fired CO₂ captures has been also focused on the power generation sector. In general, oxy-fired CO₂ capture is also less costly than post-combustion CO₂ capture across industrial sectors such as the iron and steel industries, refineries industries, and lime and cement industries, but work conducted on industrial carbon capture lags significantly behind that on the power sector, and greater levels of uncertainty exist surrounding the costs of industrial CO₂ capture and storage relative to the power sector.

Hydrogen is seen by many as the panacea of clean energy. This perception however, quickly faded when it was discovered that hydrogen does not exist in any usable forms in nature and needs to be produced artificially with technologies that are expensive and inefficient.

Currently the main feedstock for hydrogen production is hydrocarbon fuels, given their composition of hydrogen and carbon.

There are three major pathways towards H₂ production from hydrocarbon fuels, especially from natural gas containing methane. Hydrogen production through partial oxidation of solid hydrocarbons has been described above under gasification in oxygen. Listed below are other means of hydrogen production.

### 1. Steam Methane Reforming (SMR)

Steam methane reforming is widely used to produce hydrogen from a methane source, such as natural gas:

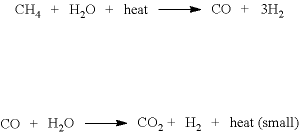

### 2. Methane Partial Oxidation in Oxygen (Autothermal Reforming-ATR)

Shown below is partial oxidation of methane in oxygen (sometimes called autothermal reforming):

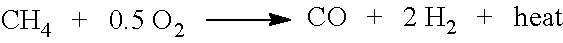

Often, there is a water gas shift reaction (WGSR) as a second step to increase the hydrogen production. The water gas shift reaction uses steam to react with the CO stream from the partial oxidation, as shown below:

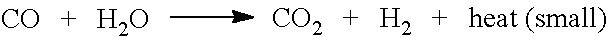

The process is typically much faster than the steam methane reforming process and requires a smaller reactor vessel. Partial oxidation can take place in the air but is diluted by the nitrogen in that situation.

In the final step of both the steam methane reforming and partial oxidation processes, CO₂ is co-produced with H₂ and needs to be removed and captured from the gas stream through a process called pressure-swing adsorption (PSA), to produce essentially pure hydrogen.

### 3. Splitting/Decomposition Reaction of Hydrocarbon

An alternative method of producing hydrogen using natural gas (CH₄) is the split or decomposition of CH₄ into H₂ and solid carbon C (or carbon black). The decomposition reaction of hydrocarbon is endothermic. Therefore, there is the need to supply energy to create this reaction to dissociate the C—H bonds. An example is the pyrolysis of natural gas, in which natural gas (mostly CH₄) is broken into solid carbon (C) and hydrogen gas (H₂).

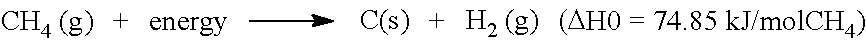

The solid carbon (C), or so-called carbon black C, must be consumed as raw materials by other products. If left unused, the carbon black C, like any other waste derived from combustion, will severely harm both aquatic and terrestrial ecosystems.

In producing 100 million tons of H₂ from CH₄ decomposition, approximately 300 million tons of the by-product carbon black C would also be produced. Currently, the annual worldwide consumption of all solid carbon products amounts to only 15 to 20 million tons, mainly in manufacturing tires and electrical components. It is unlikely that there will be any dramatic increase in carbon use in the near future.

Unless sufficiently large markets for the carbon black products are found to offset the cost of producing H₂ or it is converted to a high value product such as heat/electricity, split hydrocarbon for hydrogen production would not be economically or environmentally feasible.

Therefore, there remains the need to utilize split hydrocarbon processing (SHCP) for hydrogen production in various industrial processes and power processes in economically or environmentally feasible ways.

### SUMMARY OF THE INVENTION

Objectives of the present invention include drastically improving the economics of CO₂ capture and storage technology and also increasing the ability to embrace and develop a hydrogen economy by increasing hydrogen production throughout multiple industrial and power processes.

The present invention discloses an array of applications and their specific arrangements, aimed at the separate processing of hydrogen and carbon produced through the decomposition of natural gas and/or other hydrocarbons (or split hydrocarbon processing (SHCP)), for a range of power and industrial production purposes.

As noted above, split hydrocarbon processing (SHCP) refers to the decomposition of the carbon and hydrogen components of hydrocarbon fuels into two streams: hydrogen (H₂) and solid carbon (carbon black C).

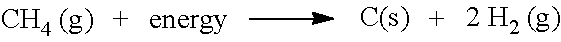

### According to the Present Invention

(1) Hydrogen (H₂) can be an exported product to generate direct revenue and/or further processed as a clean fuel through an air-fired combustion processing unit and released as nitrogen and water.

(2) The solid carbon (carbon black C) can be further utilized as an exported product to generate direct revenue and/or further processed as fuel. When used as a fuel by an air-fired combustion processing unit, the resulting carbon dioxide CO₂ will need to be separated from nitrogen. Alternatively, the solid carbon (carbon black C) is further utilized by an oxy-fired combustion processing unit, where oxygen is pre-separated from nitrogen using an air separation unit and then fed into the oxy-fired combustion processing unit. The oxy-fired combustion of solid carbon (carbon black C) produces CO₂. The CO₂ capture from the combustion of solid carbon C in oxygen will depend on the conveying mediums that transport bulk solid carbon C into the combustion process. With liquefied CO₂, a nearly pure CO₂ stream can be achieved.

### (3) Split Hydrocarbon Processing (SHCP) can be Universally Applied to:

(a) industrial production processes, and
(b) power production processes.

The present invention discloses various applications of split hydrocarbon processing (SHCP) across an array of industries. These include, but are not limited to, the oil and gas Industry, power sector, clean fuel industry, and lime/cement industry.

Within these SHCP-enabled applications, hydrogen portion is an exported product to generate direct revenue or utilized as clean fuels without regard for emissions. Meanwhile, the carbon portion is converted into energy using oxy-fired combustion processing to energize the production process and generate a nearly pure CO₂ stream for compression and storage or utilisation (CCUS). This approach facilitates the reduction of overall operating costs while also promoting resilience towards market changes and disruptions.

### Application of SHCP to the Oil and Gas Industry

Two novel processes applying SHCP to steam-assisted gravity drainage (SAGD) processes in the oil and gas industry are described below.

### HiPrOx-OTSG-SHCP: High Pressure Oxy-Fired Once Through Steam Generation (HiPrOx-OTSG) Process Incorporating SHCP

In this application, hydrogen produced from SHCP is an exported product, and part of it can be used to energize SHCP as needed. Carbon black produced from SHCP is fed to a high pressure oxy-fired once through steam generation (HiPrOx-OTSG) process as fuel to indirectly produce steam from cleaned SAGD recycled process water (PW) and fresh makeup water. This produced steam is used for steam assisted gravity drainage (SAGD) process for bitumen extraction. The high pressure flue gas from combustion containing steam and CO₂ further indirectly produces steam through heat recovery steam generation (HRSG) for a power cycle to produce electricity. Finally, the flue gas is cooled and the condensed H₂O and gaseous CO₂ are separated with the water being recycled for slurring the carbon black to the high pressure oxy-fired once through steam generation (HiPrOx-OTSG) process, while a fraction of the CO₂ is recirculated for flame moderation with the balance being ready for CO₂ compression and storage or utilisation.

### HiPrOx-DCSG-SHCP: High Pressure Oxy-Fired Direct Contact Steam Generation (HiPrOx-DCSG) Process Incorporating SHCP

In this application, hydrogen produced from SHCP is an exported product, and part of it can be used to energize SHCP as needed. Carbon black produced from SHCP is fed to a high pressure oxy-fired direct contact steam generation (HiPrOx-DCSG) process as fuel to directly produce steam from the untreated SAGD recycled process water (PW) and fresh makeup water. The produced high pressure mixture of steam (˜90%) and CO₂ (˜10%), can then be directly injected in steam assisted gravity drainage (SAGD) wells, or alternatively the H₂O can be separated by condensing the steam to water and re-boiling the water to steam for steam assisted gravity drainage (SADG) wells, leaving the CO₂ for compression and storage or utilization. Part of the condensed H₂O is recycled for conveying carbon black to the high pressure oxy-fired direct contact steam generator (HiPrOx-DCSG).

### Application of the SHCP Technology to the Power Sector

Two novel configurations incorporating SHCP to the power sector are described below:

### GTCC-SHCP: Gas Turbine Combined Cycle (GTCC) Process Incorporating SHCP

In this application, hydrogen produced from SHCP is an exported product, and part of it can be used to energize SHCP as needed. Part of the carbon black produced from SHCP is fed to a high pressure oxy-fired gasification processing unit to produce a CO stream and to indirectly generate steam for steam power cycle to produce power. The rest of the carbon black C is fed to a high pressure oxy-fired combustion processing unit to produce a CO₂ stream driving a gas turbine for power generation. Then the exhaust CO₂ stream from gas turbine is cooled by the feedwater of steam cycle and compressed to the pressure of the CO stream. Part of the CO₂ stream is recycled to the high pressure oxy-fired gasification processing unit, the rest is mixed with the CO stream for deoxygenation, then is liquefied by the condensed water of steam cycle for CO₂ compression and storage or utilization.

### Allam-SHCP: Allam Power Cycle Incorporating SHCP

In this application, hydrogen produced from SHCP is an exported product, and part of it can be used to energize SHCP as needed. Carbon black produced from SHCP is fed to a high pressure oxy-fired combustion processing unit to produce a high pressure and high temperature CO₂ stream to drive a gas turbine for power generation. Since there is no ash in the carbon black, it should have little concerns about fine solids damaging turbine blades. After recompressing and cooling, part of the exhaust CO₂ from gas turbine is recycled back to the high pressure oxy-fired combustion processing unit to moderate the combustion flame temperature and another portion is used to convey the carbon black to combustion. The remaining cooled CO₂ is ready for compression and storage or utilization.

### Application of the SHCP Technology to the Clean Fuel Industry

A novel H₂ production process for clean fuel industry incorporating split hydrocarbon processing (SHCP) is described below.

H₂-SHCP: H₂ Production Process Incorporating SHCP

In this application, hydrogen produced from SHCP is an exported product, and part of it can be used to energize SHCP as needed. Carbon black produced from SHCP is fed to a high pressure oxy-fired gasification processing that is followed by a high temperature shift reaction so that an optimal overall yield of hydrogen can be produced. This shift reaction is slightly exothermic and provides enough heat to maintain itself within the optimal range of 700-800° C. In next step, the shifted H₂-rich gas is cooled through heat recovery network to remove H₂O, hydrogen is separated using a pressure swing adsorption (PSA) to export. A portion of the CO-rich off-gas from pressure swing adsorption is sent through an amine stripper to remove CO₂, enabling the recycling of CO back to the shift reactor. The remaining CO-rich off gas is used as fuel through oxy-fired combustion to energize SHCP as needed and produce steam for regenerating the amine. This process results in nearly pure CO₂ for compression and storage or utilization.

### Application of the SHCP Technology to the Lime/Cement Production Industry

A novel configuration for lime/cement industry incorporating split hydrocarbon processing (SHCP) is described below.

### CaO-SHCP: Lime/Cement Production Incorporating SHCP

In this application, hydrogen produced from SHCP is an exported product, and part of it can be used to energize SHCP as needed. Carbon black produced from SHCP is fed to an oxy-fired combustion process to produce a high temperature CO₂ stream meeting the heat requirements for limestone calcination and cement formation. The CO₂ stream is combined with those from the calcination limestone calcination and cement formation processes. This combined CO₂ stream carries heat and is subsequently used to preheat limestone feed and then drive a power cycle to generate electricity before being cooled. After cooling, part of the CO₂ is recycled to cool the lime/cement product and back to calcination to moderate the required calcination temperature and another portion to convey the carbon black to combustion. The remaining cooled CO₂ is then ready for compression and storage or utilization.

According to one aspect of the invention, there is provided an application of split hydrocarbon processing (SHCP) to high pressure oxy-fired once through steam generation process (HiPrOx-OTSG-SHCP) for steam-assisted gravity drainage (SAGD) process, wherein:
hydrocarbon fuel is fed into a split hydrocarbon processing (SHCP) unit where decomposition of the carbon and hydrogen components takes place and the resulting products are separated into hydrogen and carbon black C,
the hydrogen is further processed through an air-fired combustion processing unit to supply energy, resulting in the release of nitrogen and water, or exported as a product,
the carbon black is fed to a high pressure oxy-fired combustion once through steam generation process unit as fuel to supply energy for the split hydrocarbon processing (SHCP) unit while indirectly produces steam for steam assisted gravity drainage (SAGD) process from cleaned SAGD recycled process water (PW) and fresh make up water,
the high pressure flue gas containing steam and CO₂ further indirectly produces steam through heat recovery steam generation for a power cycle to produce electricity, and
the condensed H₂O and gaseous CO₂ are separated with the water being recycled for slurring the carbon black while a fraction of the CO₂ is recirculated for flame moderation with the balance being ready for CO₂ compression and storage or utilization.

According to one aspect of the invention, there is provided an application of split hydrocarbon processing (SHCP) to high pressure oxy-fired direct contact steam generation (HiPrOx-DCSG-SHCP) for steam-assisted gravity drainage (SAGD) process, wherein:
hydrocarbon fuel is fed into a split hydrocarbon processing (SHCP) unit where decomposition of the carbon and hydrogen components takes place and the resulting products are separated into hydrogen and carbon black C,
the hydrogen is further processed through an air-fired combustion processing unit to supply energy, resulting in the release of nitrogen and water, or exported as a product,
the carbon black is fed to a high pressure oxy-fired direct contact steam generation (HiPrOx-DCSG) process as fuel to supply energy for the split hydrocarbon processing (SHCP) while directly produce a high pressure mixture of steam and CO₂ for steam assisted gravity drainage (SADG) process from the untreated SADG recycled process water (PW) and fresh makeup water,
the high pressure mixture of steam and CO₂ are directly injected in steam assisted gravity drainage (SADG) wells, or the steam H₂O can be separated by condensing the steam to water and re-boiling the water to steam for steam assisted gravity drainage (SADG) wells, leaving the CO₂ for compression and storage or utilization after remaining moisture is condensed, and
the condensed H₂O is recycled for conveying carbon black.

According to one aspect of the invention, there is provided an application of split hydrocarbon processing (SHCP) to gas turbine combined cycle (GTCC-SHCP) process, wherein:
hydrocarbon fuel is fed into a split hydrocarbon processing (SHCP) unit where decomposition of the carbon and hydrogen components takes place and the resulting products are separated into hydrogen and carbon black C,
the hydrogen is further processed through an air-fired combustion processing unit to supply energy, resulting in the release of nitrogen and water, or exported as a product,
a portion of the carbon black is fed to a high pressure oxy-fired gasification processing unit to supply energy for the split hydrocarbon processing (SHCP) while produce a CO stream and indirectly generate steam for steam power cycle to produce power,
the rest of the carbon black C is fed to a high pressure oxy-fired combustion processing unit to supply energy for the split hydrocarbon processing (SHCP) while produce a CO₂ stream driving a gas turbine for power generation,
the CO₂ stream after expansion is cooled by the feedwater of steam cycle and compressed to the pressure of the CO stream from the gasification process,
part of the CO₂ stream is recycled to high pressure oxy-fired combustion for temperature moderation, and
the rest of the CO₂ stream is mixed with the CO stream for deoxygenation, then is liquefied by the condensed water of steam cycle for compression and storage or utilization, and
a portion of the liquefied CO₂ stream is recycled for conveying carbon black.

According to one aspect of the invention, there is provided an application of split hydrocarbon processing (SHCP) to Allam Cycle (Allam-SHCP), wherein:
hydrocarbon fuel is fed into a split hydrocarbon processing (SHCP) unit where decomposition of the carbon and hydrogen components takes place and the resulting products are separated into hydrogen and carbon black C,
the hydrogen is further processed through an air-fired combustion processing unit to supply energy, resulting in the release of nitrogen and water, or exported as a product,
the carbon black is fed to a high pressure oxy-fired combustion processing unit to supply energy for the split hydrocarbon processing (SHCP) while produce a high pressure and high temperature CO₂ stream to drive a gas turbine for power generation,
after expansion the exhaust CO₂ is cooled and a portion of it is recycled back through compression to the high pressure oxy-fired combustion processing unit for moderating the combustion flame temperature and conveying carbon black, and
the rest of the exhaust CO₂ cooled and ready for compression and storage or utilization, and
slurry processing to convey the carbon black C with liquefied CO₂ to the high pressure oxy-fired combustion processing unit employs a flash tank to depressurize the liquefied CO₂ at room temperature, to achieve chilly gaseous CO₂ and chilly liquid CO₂, the chilly gaseous CO₂ then transports the carbon black C to a slurry tank, where it mixes with the chilly liquid CO₂ to produce a chilly CO₂ and carbon C slurry.

According to one aspect of the invention, there is provided an application of split hydrocarbon processing (SHCP) to hydrogen production for clean fuel process (H₂-SHCP), wherein:
hydrocarbon fuel is fed into a split hydrocarbon processing (SHCP) unit where decomposition of the carbon and hydrogen components takes place and the resulting products are separated into hydrogen and carbon black C,
the hydrogen is further processed through an air-fired combustion processing unit to supply energy, resulting in the release of nitrogen and water, or exported as a product,
the carbon black is fed to a high pressure oxy-fired gasification followed by a high temperature shift reaction slightly exothermic and provides sufficient heat to maintain within the optimal range of 700-800° C.,
the shifted gas is cooled through heat recovery network to remove H₂O for reuse of making carbon C slurry,
hydrogen is separated using a pressure swing adsorption (PSA) unit for export, and
a portion of the off-gas from pressure swing adsorption is sent through an amine stripper to remove CO₂ and the remaining CO rich gas is then recycled back to the shift processing through compression, and
the remaining off-gas from the pressure swing adsorption and the amine stripper undergoes CO oxy-fired combustion processing to supply energy for the split hydrocarbon processing (SHCP) and the amine stripper.

According to one aspect of the invention, there is provided an application of split hydrocarbon processing (SHCP) to lime or cement production process (CaO-SHCP), wherein:
hydrocarbon fuel is fed into a split hydrocarbon processing (SHCP) unit where decomposition of the carbon and hydrogen components takes place and the resulting products are separated into hydrogen and carbon black C,
the hydrogen is further processed through an air-fired combustion processing unit to supply energy, resulting in the release of nitrogen and water, or exported as a product,
the carbon black is fed to an oxy-fired combustion process unit to supply energy for the split hydrocarbon processing (SHCP) while produce a high temperature CO₂ stream meeting the heat requirement of calcination reaction of limestone,
the CO₂ stream is combined with a second CO₂ stream produced from a calcination reaction in a calcination processing unit,
after exiting the calcination, the combined CO₂ stream is used to drive a power cycle to generate electricity while undergoes cooling,
a portion of the cooled CO₂ is recycled to cool the lime or cement product and back to the calcination reaction for moderating the required calcination temperature, and
another portion of the cooled CO₂ is recycled to convey carbon black, and
the rest of the cooled CO₂ is ready for compression and storage or utilization.

Other features and advantages of the present invention will become apparent from the following detailed description and the accompanying drawings, which illustrate, by way of example, the principles of the invention.

### BRIEF DESCRIPTION OF THE DRAWINGS

By way of example only, embodiments of the present invention are described hereinafter with reference to the accompanying drawings, wherein:

FIG. 1a is a schematic representation of an embodiment of general industrial production processes incorporating split hydrocarbon processing (SHCP) for producing H₂, intended products and generating CO₂ wherein oxy-fired combustion processing. The CO₂ output is ready for compression and storage or utilization;

FIG. 1b is a schematic representation of an embodiment of general power production processes incorporating split hydrocarbon processing (SHCP) for producing H₂, power and generating CO₂ wherein oxy-fired combustion processing. The CO₂ output is ready for compression and storage or utilization;

FIG. 2 is a schematic representation of an embodiment of general industrial production processes incorporating split hydrocarbon processing (SHCP) for producing H₂, intended products and generating CO₂ wherein air-fired combustion processing. Post-combustion CO₂ separation is used for CO₂ capture, after which it is ready for compression and storage or utilization;

FIG. 3 is a schematic representation of an embodiment of a high pressure oxy-fired once through steam generation (HiPrOx-OTSG) process incorporating split hydrocarbon processing (SHCP) for producing H₂, steam for SAGD, power, and generating CO₂ wherein oxy-fired combustion processing. The CO₂ output is ready for compression and storage or utilization;

FIG. 4 is a schematic representation of an embodiment of a high pressure oxy-fired direct contact steam generation (HiPrOx-DCSG) process incorporating split hydrocarbon processing (SHCP) for producing H₂, steam for SAGD, and generating CO₂ wherein oxy-fired combustion processing. The CO₂ output is ready for compression and storage or utilization;

FIG. 5 is a schematic representation of an embodiment of a gas turbine combined cycle (GTCC) process incorporating split hydrocarbon processing (SHCP) for producing H₂, power and generating CO₂ wherein oxy-fired combustion and gasification processing. The CO₂ output is ready for compression and storage or utilization;

FIG. 6 is a schematic representation of an embodiment of an Allam power cycle incorporating split hydrocarbon processing (SHCP) for producing H₂, power and generating CO₂ wherein oxy-fired combustion processing. The CO₂ output is ready for compression and storage and or utilization;

FIG. 7 is a schematic representation of an embodiment of a carbon gasification process incorporating split hydrocarbon processing (SHCP) for producing H₂, power and generating CO₂ wherein oxy-fired gasification processing. The CO₂ output is ready for compression and storage or utilization; and

FIG. 8 is a schematic representation of an embodiment of a lime/cement production process incorporating split hydrocarbon processing (SHCP) for producing H₂, power, lime/cement and generating CO₂ wherein oxy-fired combustion processing. The CO₂ output is ready for compression and storage or utilization.

### DETAILED DESCRIPTION OF THE INVENTION

It is to be understood that the disclosure is not limited in its application to the details of the embodiments as set forth in the following description. The invention is capable of other embodiments and of being practiced or of being carried out in various ways. By way of example only, preferred embodiments of the present invention are described hereinafter with reference to the accompanying drawings.

Furthermore, it is to be understood that the terminology used herein is for the purpose of description and should not be regarded as limiting. Contrary to the use of the term “consisting”, the use of the terms “including”, “containing”, “comprising”, or “having” and variations thereof is meant to encompass the items listed thereafter and equivalents thereof as well as additional items. The use of the term “a” or “an” is meant to encompass “one or more”.

Fuel is a solid, liquid, or gaseous hydrocarbon, or carbon, or hydrogen, or a mixture thereof.

Carbon can be the waste carbon black generated from a natural gas pyrolysis system that produces hydrogen, or another source of carbon, such as petroleum coke.

Processes mean industrial processes and include power generation and oil and gas processes.

Split hydrocarbon processing (SHCP) refers to the decomposition of the carbon and hydrogen components of hydrocarbon fuels into two streams: hydrogen and solid carbon, and these resultant energy products—hydrogen (H₂) and solid carbon (carbon black C)—are subsequently exported as products or utilized in diverse production processes.

For example, after the decomposition of CH₄ into hydrogen and solid carbon, 45% of the energy value of CH₄ goes to solid carbon (C) and 55% to hydrogen (H₂), as shown in Table 1.

TABLE 1
SHCP Low Heat Value (LHV) Energy Balance

| Split | | | Energy/ | | | | |
|---|---|---|---|---|---|---|---|
| Reaction | CH₄ | | mol CH₄ | | 2 H₂ | | C |
| LHV, kJ/mole | 802 | + | 75 | → | 2 × 242 | + | 393.5 |
| Percentage | 91% | | 9% | | 55% | | 45% |

As addressed earlier, the approach of burying the solid carbon stream, known as “solid carbon sequestration”, has detrimental effects on both aquatic and terrestrial ecosystems if there is not viable market to consume it. Moreover, this approach results in a 45% loss of the energy value of CH₄. The solution as disclosed by the present invention addresses the carbon C stream differently by fully harnessing its energy value through oxidation in oxygen, resulting in nearly pure CO₂ that is ready for compression and storage or utilization. This approach offers unique advantages over conventional CO₂ capture methods from CH₄ combustion.

Table 2 compares, based on supplying the same amount of energy output, the conventional combustion of 1 mole of CH₄ in both air-fired and oxy-fired combustion modes against two scenarios of the CH₄ split hydrocarbon processing and combustion.

In Table 2, the conventional combustion of 1 mole of CH₄ supplies 802 KJ/mole (LHV), while produces 10.52 moles of flue gas with 9.5% of CO₂ in air-fired combustion mode and produces 3 moles of flue gas with 33.3% of CO₂ in oxy-fired combustion mode. Before the CO₂ can be captured, an additional CO₂ separation process is required for both modes.

In the first scenario of the CH₄ split hydrocarbon processing, splitting 1 mole of CH₄ produces 2 moles of H₂ and 1 mole of C. All the H₂ can be burnt in air-fired combustion mode, producing no green house gas emissions. A portion of the H₂ (0.31 mol) can supply energy (−75 KJ/mol) required for splitting 1 mole of CH₄. The entire carbon (C) can be burnt in oxy-fired combustion mode, producing only 1 mole of flue gas with 100% of CO₂ requiring no separation, while supplying the same energy output of 802 KJ/mole (LHV). Moreover, this scenario consumes only 1 mole of O₂ that is just half of the O₂ consumption of the conventional combustion of 1 mole of CH₄ in oxy-fired combustion mode. Therefore, the first scenario reduces costs and energy penalty for CO₂ capture by using a smaller air separation unit, handling much less flue gas (1 mole vs. 10.52 moles or 3 moles) and capturing CO₂ without CO₂ separation.

In the second scenario of the CH₄ split hydrocarbon processing, splitting 2.04 moles of CH₄ produces 4.08 moles of H₂ and 2.04 moles of C. 15% H₂ (0.63 mol) can be burnt in air-fired combustion mode, producing no green house gas emissions, to supply energy (−153 KJ/mol) for splitting 2.04 moles of CH₄. The entire carbon (C) can be burnt in oxy-fired combustion mode, producing 2.04 mole of flue gas with 100% of CO₂ requiring no separation, while supplying the same energy output of 802 KJ/mole (LHV). Moreover, the second scenario consumes 2.04 mole of O₂ that is slightly more than the 2 moles of O₂ consumed by the conventional combustion of 1 mole of CH₄ in oxy-fired combustion mode but is able to use 2.04 moles of CH₄ for producing 3.44 moles of H₂ as a product or clean fuel for other applications or market. Therefore, the advantage of this second scenario is that it is able to reduce cost and energy penalty for CO₂ capture by using the same size air separation unit, handling much less flue gas (2.04 moles vs. 10.52 moles or 3 moles), capturing CO₂ without CO₂ separation and producing 3.44 moles of H₂ as a product or clean fuel.

TABLE 2
Comparison of CH₄ combustion and CH₄ split hydrocarbon processing
combustion for the same amount of energy output

CH₄ combustion: material balance and energy output (LHV)

| | | | | | | | | | | | | | Flue | H2 |
|---|---|---|---|---|---|---|---|---|---|---|---|---|---|---|
| | CH₄, | O₂, | N₂, | C(s), | H2, | | H₂O, | CO₂, | N2, | C(s), | H₂, | LHV, | gas, mol | Product |
| Mode | mol | mol | mol | mol | mol | — | mol | mol | mol | mol | mol | kJ/mol | (CO2%) | mol |
| air-fired | 1.00 | 2.00 | 7.52 | | | | 2.00 | 1.00 | 7.52 | | | −802⁽²⁾ | 10.52 | |
| combustion | | | | | | | | | | | | | 9.5% | |
| oxy-fired⁽³⁾ | 1.00 | 2.00 | | | | | 2.00 | 1.00 | | | | −802⁽²⁾ | 3.00 | |
| combustion | | | | | | | | | | | | | 33.3% | |

CH₄ SHCP material balance and energy balance (LHV)
Scenario 1 combustion of 100% H₂ and 100% C for energy supply, without H2 production

| | | | | | | | | | | | | | Flue | H₂ |
|---|---|---|---|---|---|---|---|---|---|---|---|---|---|---|
| | CH₄, | O₂, | N₂, | C(s), | H2, | | H2O, | CO₂, | N2, | C(s), | H₂, | LHV, | gas, mol | Product |
| Mode | mol | mol | mol | mol | mol | — | mol | mol | mol | mol | mol | kJ/mol | (CO2%) | mol |
| CH4 SHCP | 1.00 | | | | | | | | | 1.00 | 2.00 | 75 | | |
| H₂ air-fired | | 0.16 | 0.58 | | 0.31 | | 0.31 | | 0.58 | | | −75⁽¹⁾ | | |
| combustion | | | | | | | | | | | | | | |
| H2 air-fired | | 0.84 | 3.18 | | 1.69 | | 0.84 | | 3.18 | | | −409⁽²⁾ | | |
| combustion | | | | | | | | | | | | | | |
| C oxy-fired⁽³⁾ | | 1.00 | | 1.00 | | | | 1.00 | | | | −394⁽²⁾ | 1.00 | |
| combustion | | | | | | | | | | | | | 100% | |

CH₄ SHCP material balance and energy balance (LHV)
Scenario 2 combustion of 15% H₂ and 100% C for energy supply, with H₂ production

| | | | | | | | | | | | | | Flue | H₂ |
|---|---|---|---|---|---|---|---|---|---|---|---|---|---|---|
| | CH₄, | O₂, | N₂, | C(s), | H2, | | H₂O, | CO₂, | N2, | C(s), | H₂, | LHV, | gas, mol | Product |
| Mode | mol | mol | mol | mol | mol | — | mol | mol | mol | mol | mol | kJ/mol | (CO2%) | mol |
| CH4 SHCP | 2.04 | | | | | | | | | 2.04 | 4.08 | 153 | | 3.44 |
| H2 air-fired | | 0.32 | 1.19 | | 0.63 | | 0.63 | | 1.19 | | | −153⁽¹⁾ | | |
| combustion | | | | | | | | | | | | | | |
| C oxy-fired⁽³⁾ | | 2.04 | | 2.04 | | | | 2.04 | | | | −802⁽²⁾ | 2.04 | |
| combustion | | | | | | | | | | | | | 100% | |

Notes:
⁽¹⁾Energy needed to split CH₄,
⁽²⁾Energy output from the combustion,
⁽³⁾Energy needed to separate O₂ from air by ASU is not included in this table. In general, comparing oxy-fired combustion CO₂ capture with post-combustion CO₂ capture, energy needed for separating O₂ from air is less than energy needed for separating CO₂ from flue gas.

Therefore, CH₄ split hydrocarbon processing combustion can result in a better energy and economic performance than conventional combustion of CH₄ in both air-fired and oxy-fired combustion modes.

The present invention has the following characteristics and advantages:
It employs split hydrocarbon processing (SHCP) to make separate solid carbon C stream and hydrogen H₂ stream from a hydrocarbon fuel, and handles the separated solid carbon C stream and hydrogen H₂ stream differently;
It integrates the split hydrocarbon processing (SHCP) into a variety of industrial and power processes to allow a localized production of clean H₂ stream;
It utilizes the clean H₂ stream as an exported product or a clean fuel for other applications, and/or utilizes part of the clean H₂ stream as fuel in air-combustion to energize split hydrocarbon processing (SHCP) for the intended industrial or power processes;
It utilizes the solid carbon C stream as fuel in oxy-fired combustion to energize the intended industrial or power processes, and/or utilizes part of the solid carbon C stream to energize the split hydrocarbon processing (SHCP); and
It produces nearly pure CO₂ effluent streams universal to different industrial or power processes with the aim that the CO₂ output is ready for compression and storage or utilization.

According to the present invention, split hydrocarbon processing (SHCP) for producing hydrogen and generating pure CO₂ is a universal approach that can be applied to different industrial and/or power processes. This approach allows different industrial and/or power processes to locally produce clean hydrogen H₂ as an exported product or as a clean fuel. This approach also allows different industrial and power processes to fully utilize the energy of carbon C and produce pure CO₂ ready for compression and storage or utilization.

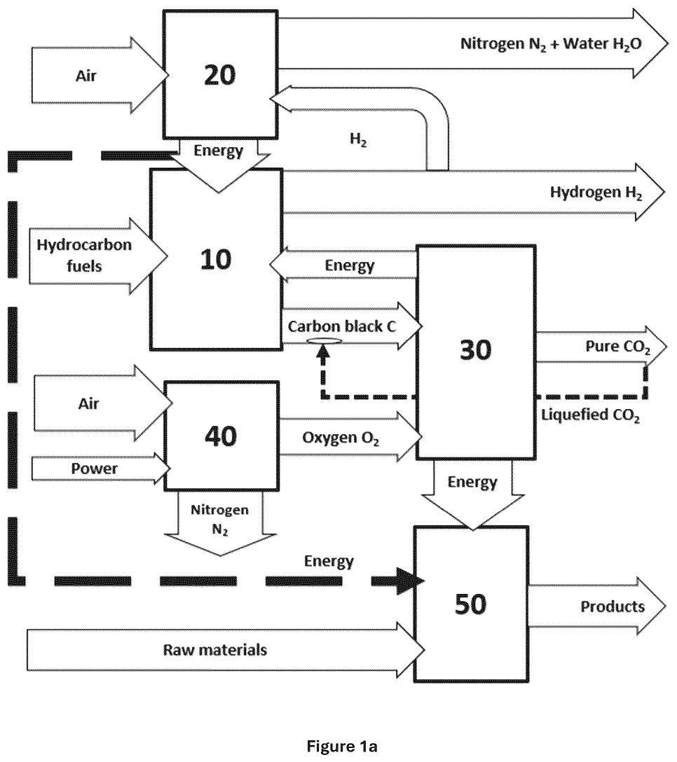

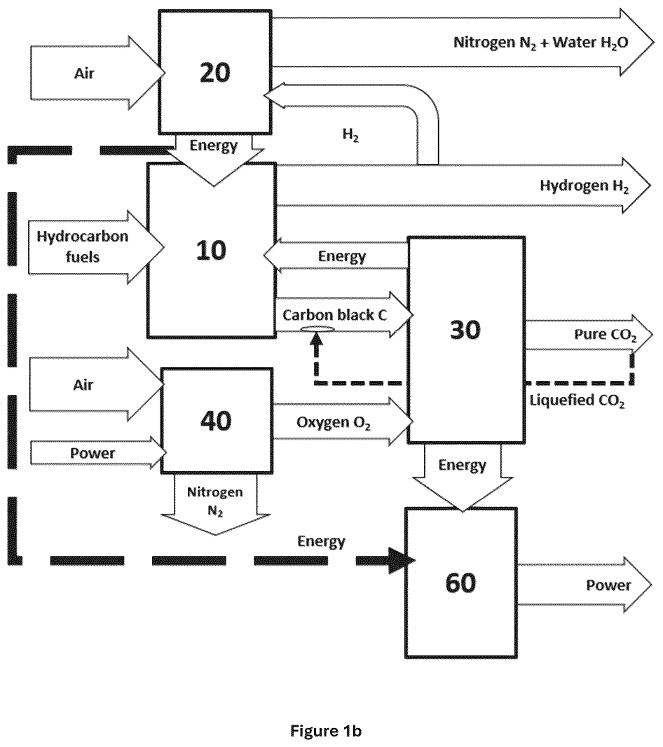

FIGS. 1a and 1b are, respectively, schematic representations of:
a. an embodiment of industrial production processes, and
b. an embodiment of power production processes.

Both using split hydrocarbon processing (SHCP) for H₂ production and intended product production, while generating CO₂ for compression and storage or utilization.

Referring to FIGS. 1a and 1b, hydrocarbon fuels are fed into split hydrocarbon processing (SHCP) unit 10 where decomposition of the carbon and hydrogen components takes place. The resulting products are separated into two streams: hydrogen (H₂) and solid carbon (carbon black C).

Hydrogen (H₂) can be exported and/or further processed through an air-fired combustion processing unit 20 to supply energy, resulting in the release of nitrogen and water. The hydrogen H₂ is an exported product, and part of it can be used to energize the split hydrocarbon processing unit 10 if needed.

The solid carbon (carbon black C) is further processed by an oxy-fired combustion processing unit 30, where oxygen is pre-separated from nitrogen using an air separation unit (ASU) 40 and is also fed into the oxy-fired combustion processing unit 30. An air separation unit (ASU) 40 is a device that separates air into its components, primarily oxygen, nitrogen, and argon.

The oxy-fired combustion of solid carbon (carbon black C) supplies energy for the split hydrocarbon processing unit 10 and the production process while produces CO₂. The CO₂ capture from the oxy-fired combustion unit 30 will depend on the conveying mediums that transport bulk solid carbon C into the combustion process. With liquefied CO₂, a nearly pure CO₂ stream can be achieved.

The oxy-fired combustion processing unit 30 can burn the solid carbon (carbon black C) under ambient pressure or at above ambient pressure.

As an illustrative example, high pressure oxy-fired (HiPrOx) combustion requires the entire system at pressure resulting in the release of a pressurized CO₂ stream. The pressure needs to be as high as above 75 bars allowing for the liquefaction of CO₂ stream at near-ambient temperatures for pipeline transportation. In such a way, the high energy penalties of compressing gaseous CO₂ are avoided. Furthermore, a high pressure oxy-fired (HiPrOx) combustion system is more compact.

The difference between FIGS. 1a and 1b is that in FIG. 1a the split hydrocarbon processing unit 10 is applied to industrial production processing 50 on raw materials to provide products, whereas in FIG. 1b the split hydrocarbon processing unit 10 is applied to power production processing 60 to provide electricity.

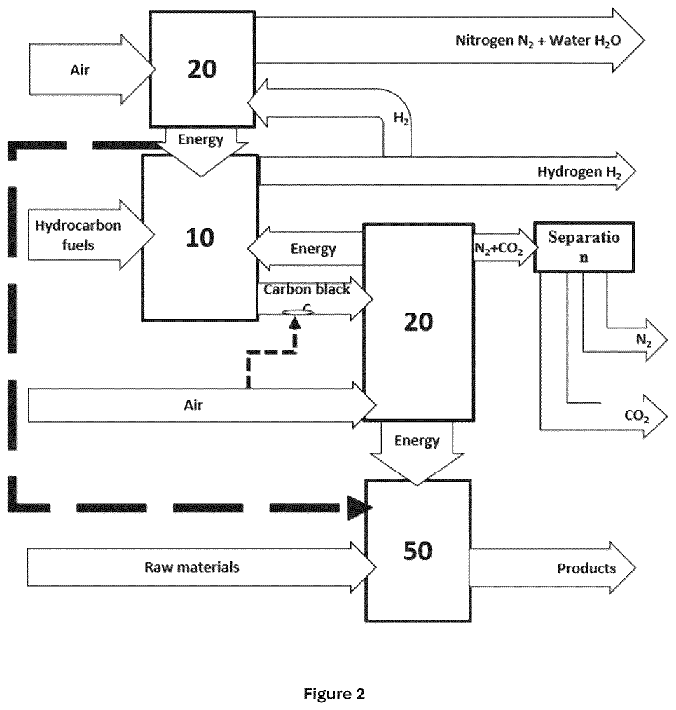

FIG. 2 is a schematic representation of an embodiment of industrial production process 50 using split hydrocarbon processing (SHCP) unit 10 for H₂ production and intended product production, while generating CO₂ in air-fired combustion processing unit 20. Post-combustion CO₂ capture is used for CO₂ separation, followed by compression and storage or utilization.

Referring to FIG. 2, hydrocarbon fuels are fed into split hydrocarbon processing (SHCP) unit 10 where decomposition of the carbon and hydrogen components takes place. The resulting products are separated into two streams: hydrogen (H₂) and solid carbon (carbon black C).

Hydrogen (H₂) can be exported and/or further processed through a first air-fired combustion processing unit 20 to supply energy, resulting in the release of nitrogen and water. The hydrogen H₂ is an exported product, and part of it can be used to energize the split hydrocarbon processing unit 10 if needed.

The solid carbon (carbon black C) is further processed by a second air-fired combustion processing unit 20 (as opposed to an oxy-fired combustion processing unit 30 in FIG. 1a). This is particularly applicable where the air-fired combustion processing is available and less costly than oxy-fired combustion CO₂ capture.

Similar process (using an air-fired combustion processing unit 20 as opposed to an oxy-fired combustion processing unit 30 as depicted in FIG. 1b) for power production processing can also be employed.

### Application of SHCP to the Oil and Gas Industry

The approach of using split hydrocarbon processing (SHCP) can be applied to the oil and gas industry for bitumen extraction using steam assisted gravity drainage (SAGD) process. As disclosed herein, two novel steam-assisted gravity drainage (SAGD) processes incorporating split hydrocarbon processing (SHCP) are described below:
1. a high pressure oxy-fired once through steam generation (HiPrOx-OTSG-SHCP) process; and
2. a high pressure oxy-fired direct contact steam generation (HiPrOx-DCSG-SHCP) process.

### HiPrOx-OTSG-SHCP: High Pressure Oxy-Fired Once Through Steam Generation (HiPrOx-OTSG) Process Incorporating SHCP

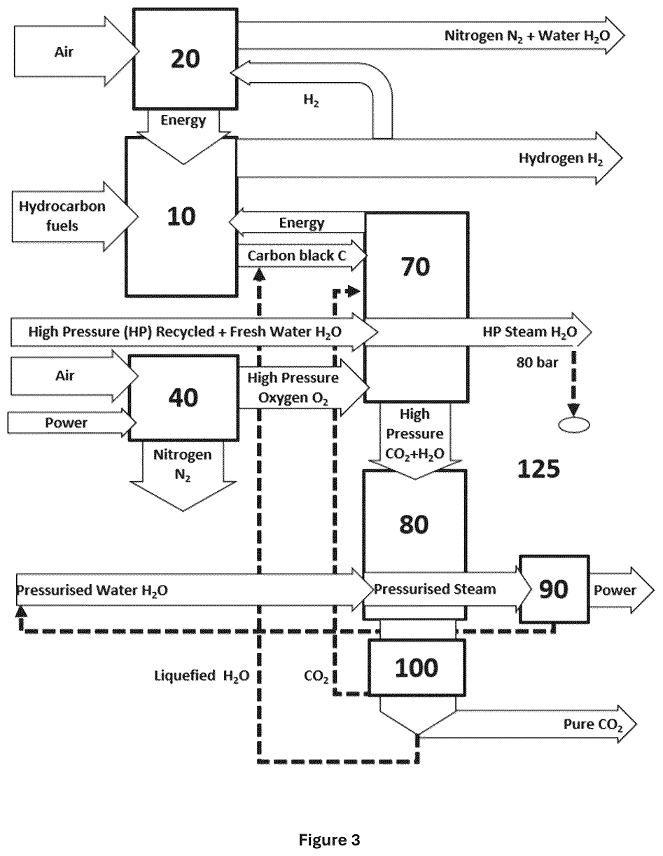

FIG. 3 is a schematic representation of an embodiment of high pressure oxy-fired once through steam generation process using split hydrocarbon processing (HiPrOx-OTSG-SHCP) for steam assisted gravity drainage (SAGD) process to extract bitumen, while producing H₂, power and generating CO₂ for compression and storage or utilization.

Referring to FIG. 3, hydrocarbon fuels are fed into split hydrocarbon processing (SHCP) unit 10 where decomposition of the carbon and hydrogen components takes place. The resulting products are separated into two streams: hydrogen (H₂) and solid carbon (carbon black C).

Hydrogen (H₂) can be exported and/or further processed through an air-fired combustion processing unit 20 to supply energy, resulting in the release of nitrogen and water. The hydrogen H₂ is an exported product, and part of it can be used to energize the split hydrocarbon processing unit 10 if needed.

The carbon black C is fed to a high pressure oxy-fired once through steam generation (HiPrOx-OTSG) processing unit 70 as fuel. Oxygen is pre-separated from nitrogen using an air separation unit (ASU) 40 and is also fed into the high pressure oxy-fired once through steam generation (HiPrOx-OTSG) processing unit 70. This high pressure oxy-fired once through steam generation (HiPrOx-OTSG) processing unit 70 produces the energy required for the split hydrocarbon processing unit 10 and indirectly produces steam for steam assisted gravity drainage (SAGD) wells 125 from cleaned SAGD recycled process water (PW) and fresh make up water.

The high-pressure flue gas from the high pressure oxy-fired once through steam generation (HiPrOx-OTSG) processing unit 70 containing steam and CO₂ further indirectly produces steam through heat recovery steam generation (HRSG) unit 80 for a steam turbine 90 to produce electricity. Then the flue gas is cooled in a flue gas condenser 100. Finally, the condensed H₂O and gaseous CO₂ are separated with the water being recycled for slurring the carbon black while a fraction of the CO₂ is recirculated for flame moderation in the high pressure oxy-fired once through steam generation (HiPrOx-OTSG) processing unit 70 with the balance being ready for CO₂ compression and storage or utilization.

### HiPrOx-DCSG-SHCP: High Pressure Oxy-Fired Direct Contact Steam Generation (HiPrOx-DCSG) Process Incorporating SHCP

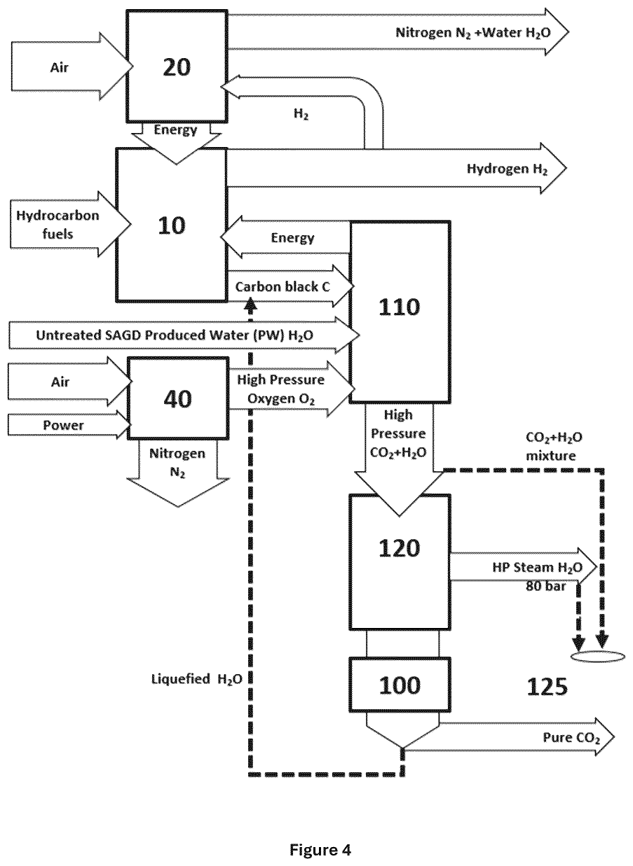

FIG. 4 is a schematic representation of an embodiment of high pressure oxy-fired direct contact steam generation (HiPrOx-DCSG) process using split hydrocarbon processing (SHCP) for steam assisted gravity drainage (SAGD) process to extract bitumen, while producing H₂ and generating CO₂ for compression and storage or utilization.

Direct contact steam generation allows the fuel and the water to come in direct contact in oxy-fired combustion to produce a mixture of steam (˜90%) and CO₂ (˜10%) for the steam assisted gravity drainage (SAGD) process. The water used for the steam assisted gravity drainage process is the untreated SAGD recycled process water (PW).

Referring to FIG. 4, hydrocarbon fuels are fed into split hydrocarbon processing (SHCP) unit 10 where decomposition of the carbon and hydrogen components takes place. The resulting products are separated into two streams: hydrogen (H₂) and solid carbon (carbon black C).

Hydrogen (H₂) can be exported and/or further processed through an air-fired combustion processing unit 20 to supply energy, resulting in the release of nitrogen and water. The hydrogen H₂ is an exported product, and part of it can be used to energize the split hydrocarbon processing unit 10 if needed.

The carbon black C is fed to a high pressure oxy-fired direct contact steam generation (HiPrOx-DCSG) processing unit 110 as fuel. Oxygen is pre-separated from nitrogen using an air separation unit (ASU) 40 and is also fed into the high pressure oxy-fired direct contact steam generation (HiPrOx-DCSG) processing unit 110. This high pressure oxy-fired direct contact steam generation (HiPrOx-DCSG) processing unit 110 produces the energy required for the split hydrocarbon processing unit 10 and directly produces steam from the untreated SAGD recycled process water (PW) and fresh make up water. The high pressure mixture of steam (˜90%) and CO₂ (˜10%) can then be directly injected in steam assisted gravity drainage (SAGD) wells 125 for bitumen extraction, or can be processed through a CO₂ and steam separation unit 120 where the H₂O can be separated by condensing the steam to water and re-boiling the water to steam (˜100%) for steam assisted gravity drainage (SAGD) wells 125. The CO₂ with remaining steam passes a flue gas condenser 100 for further cooling. The condensed H₂O is recycled for conveying carbon black, leaving gaseous CO₂ for compression and storage or utilization.

### Application of the SHCP Technology to the Power Sector

The approach of using split hydrocarbon processing (SHCP) can also be applied to the power industry. As disclosed herein, two novel configurations for power cycles incorporating split hydrocarbon processing (SHCP) are described below:
1. Gas turbine combined cycle (GTCC) process incorporating split hydrocarbon processing (SHCP) for H₂ and power production, while generating CO₂ for compression and storage or utilization; and
2. Allam cycle incorporating split hydrocarbon processing (SHCP) for H₂ and power production, while generating CO₂ for compression and storage or utilization.

### GTCC-SHCP: Gas Turbine Combined Cycle (GTCC) Process Incorporating SHCP

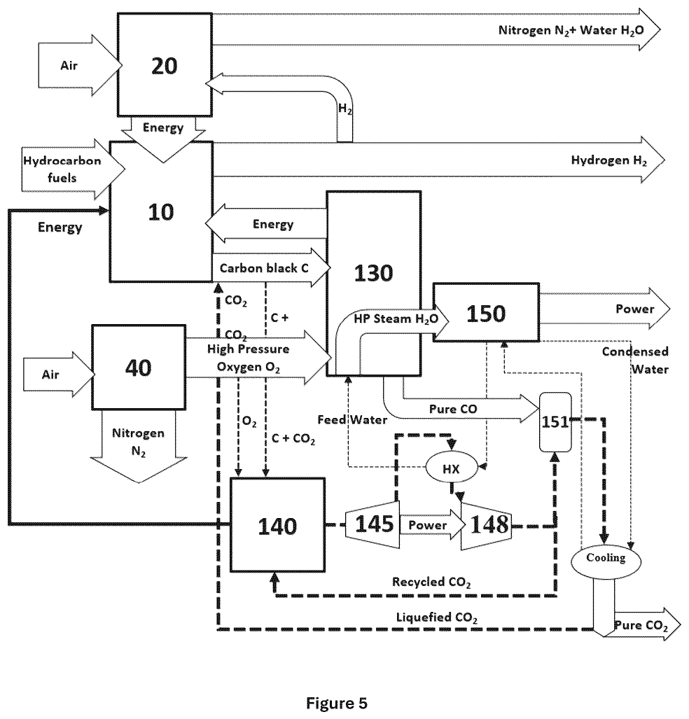

FIG. 5 is a schematic representation of an embodiment of gas turbine combined cycle process incorporating split hydrocarbon processing (GTCC-SHCP).

Gas turbine combined cycle (GTCC) generates power using a gas turbine and a steam turbine.

Referring to FIG. 5, hydrocarbon fuels are fed into split hydrocarbon processing (SHCP) unit 10 where decomposition of the carbon and hydrogen components takes place. The resulting products are separated into two streams: hydrogen (H₂) and solid carbon (carbon black C).

Hydrogen (H₂) can be exported and/or further processed through an air-fired combustion processing unit 20 to supply energy, resulting in the release of nitrogen and water. The hydrogen H₂ is an exported product, and part of it can be used to energize the split hydrocarbon processing unit 10 if needed.

Part of the carbon black C from the split hydrocarbon processing unit 10 is fed to a high pressure oxy-fired gasification (HiPrOx-G) processing unit 130 as fuel. Oxygen is pre-separated from nitrogen using an air separation unit (ASU) 40 and is also fed into the high pressure oxy-fired gasification (HiPrOx-G) processing unit 130. This high pressure oxy-fired gasification (HiPrOx-G) processing unit 130 produces the energy required for split hydrocarbon processing unit 10, a CO stream, and indirectly generate steam for steam power cycle 150 to generate power.

The rest of the carbon black C is fed to a high pressure oxy-fired combustion (HiPrOx-C) processing unit 140 to produce a CO₂ stream driving a gas turbine 145 for power generation. Then the CO₂ stream is cooled by the feedwater of the steam power cycle unit 150 and compressed by a CO₂ compressor 148 to the pressure of the CO stream from the high pressure oxy-fired gasification (HiPrOx-G) processing unit 130.

Part of the pressurized CO₂ stream is recycled to high pressure oxy-fired combustion unit 140, the rest is mixed with the CO stream for deoxygenation in a deoxygenation unit 151, then is liquefied by the condensed water of steam power cycle 150. A portion of the liquefied CO₂ is used to convey the carbon black C to both the high pressure oxy-fired gasification (HiPrOx-G) processing unit 130 and the high pressure oxy-fired combustion (HiPrOx-C) processing unit 140, the rest is ready for CO₂ compression and storage or utilization.

### Allam-SHCP: Allam Power Cycle Incorporating SHCP

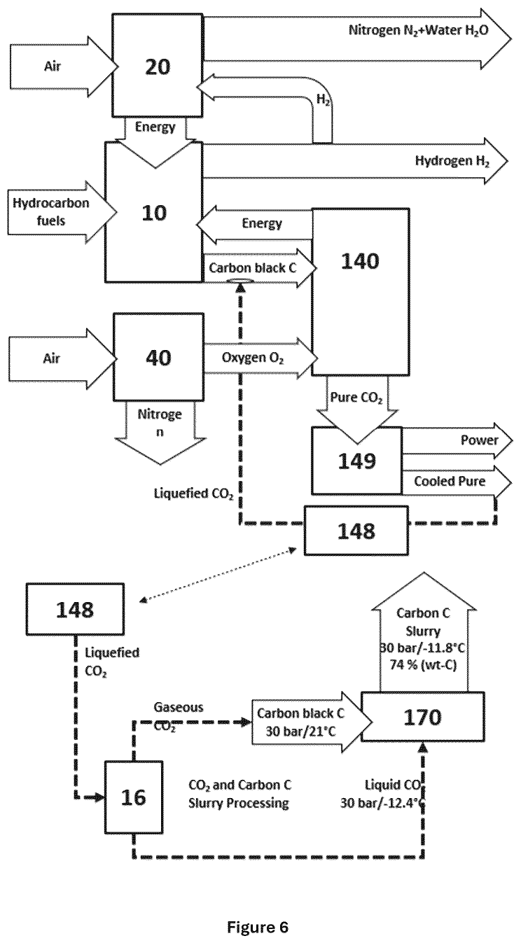

FIG. 6 is a schematic representation of an embodiment of an Allam cycle incorporating split hydrocarbon processing (SHCP).

The Allam cycle is a gas turbine cycle using super critical CO₂ for power generation and output the CO₂ for sequestration.

Referring to FIG. 6, hydrocarbon fuels are fed into split hydrocarbon processing (SHCP) unit 10 where decomposition of the carbon and hydrogen components takes place. The resulting products are separated into two streams: hydrogen (H₂) and solid carbon (carbon black C).

Hydrogen (H₂) can be exported and/or further processed through an air-fired combustion processing unit 20 to supply energy, resulting in the release of nitrogen and water. The hydrogen H₂ is an exported product, and part of it can be used to energize the split hydrocarbon processing unit 10 if needed.

The carbon black C from the split hydrocarbon processing unit 10 is fed to a high pressure oxy-fired combustion (HiPrOx-C) processing unit 140. Oxygen is pre-separated from nitrogen using an air separation unit (ASU) 40 and is also fed into the high pressure oxy-fired combustion (HiPrOx-C) processing unit 140. This high pressure oxy-fired combustion (HiPrOx-C) processing unit 140 produces the energy required for the split hydrocarbon processing unit 10 and a high pressure and high temperature CO₂ stream to drive an Allem cycle unit 149 for power generation. Since there is no ash in the carbon black, it should have little concerns about fine solids damaging blades of the gas turbine within the Allem cycle unit 149. A part of the exhaust CO₂ from the gas turbine within the Allem cycle unit 149 is compressed by a CO₂ compressor 148 and cooled to liquid state. This liquefied CO₂ after the CO₂ compressor 148 is used to convey the carbon black C and recycled back to the high pressure oxy-fired combustion processing unit 140 for moderating the combustion flame temperature. The rest is ready for compression and storage or utilization.

To generate a nearly pure CO₂ stream with no need of separation for CO₂ compression and storage or utilization, it requires slurry processing to convey the carbon black C with liquefied CO₂ to the high pressure oxy-fired combustion processing unit 140. The slurry process employs a flash tank 160 to depressurize the liquefied CO₂ at room temperature (85 bar/21° C.) to achieve chilly gaseous CO₂ and chilly liquid CO₂, for example, both at about 30 bar/−12.4° C. The chilly gaseous CO₂ then transports the carbon black C to a slurry tank 170, where it mixes with the chilly liquid CO₂ to produce a chilly CO₂ and carbon C slurry by 74% weight of carbon C. This slurry is further pressurized to match the pressure of the high pressure oxy-fired combustion processing unit 140.

### Application of the SHCP Technology to the Clean Fuel Industry

The approach of using split hydrocarbon processing (SHCP) can be applied to clean fuel industry. A novel H₂ production process incorporating split hydrocarbon processing (SHCP) is described below.

H₂-SHCP: H₂ Production Process Incorporating SHCP

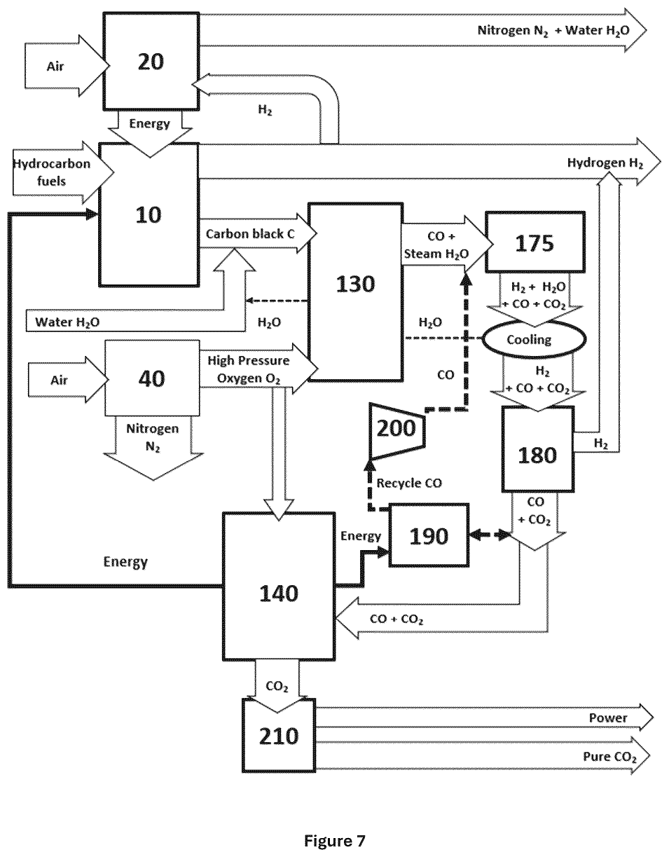

FIG. 7 is a schematic representation of an embodiment of carbon gasification process incorporating split hydrocarbon processing (SHCP).

Gasification of solid fuels for hydrogen H₂ production through partial oxidation and water-gas shift reaction leaving a CO₂-rich flue gas for capture has been described in section 2 Gasification in Oxygen.

Referring to FIG. 7, hydrocarbon fuels are fed into split hydrocarbon processing (SHCP) unit 10 where decomposition of the carbon and hydrogen components takes place. The resulting products are separated into two streams: hydrogen (H₂) and solid carbon (carbon black C).

Hydrogen (H₂) can be exported and/or further processed through an air-fired combustion processing unit 20 to supply energy, resulting in the release of nitrogen and water. The hydrogen H₂ is an exported product, and part of it can be used to energize the split hydrocarbon processing unit 10 if needed.

The carbon black C from the split hydrocarbon processing unit 10 is fed to a high pressure oxy-fired gasification unit 130 as fuel. Oxygen is pre-separated from nitrogen using an air separation unit (ASU) 40 and is also fed into the high pressure oxy-fired gasification unit 130 to produce a mixture of CO and steam H₂O.

This followed by a high temperature shift reaction which takes place in a high temperature shift processing unit 175 so that the highest overall yield of hydrogen H₂ can be produced. This shift reaction is slightly exothermic and provides enough heat to maintain itself within the optimal range of 700-800° C.

In next step, the shifted gas is cooled through heat recovery network to remove H₂O for reuse of making carbon C slurry, then hydrogen is separated using a pressure swing adsorption (PSA) unit 180 for export. A portion of the off-gas from pressure swing adsorption unit 180 is sent through an amine stripper 190 to remove CO₂ and the remaining CO rich gas is then recycled back to the shift processing unit 175 through a CO compressor 200. The remaining off-gas from the pressure swing adsorption unit 180 and the amine stripper 190 undergoes CO oxy-fired combustion processing unit 140. This process not only supplies energy for split hydrocarbon processing unit 10 and amine stripper 190 but also generates a high-temperature and pure CO₂ stream. Subsequently, this CO₂ stream drives a power cycle unit 210 to produce power while simultaneously undergoing cooling for compression and storage or utilization.

### Application of the SHCP Technology to the Lime/Cement Production Industry

The approach of using split hydrocarbon processing (SHCP) can be applied to lime/cement production industry. A novel configuration for lime/cement production incorporating split hydrocarbon processing (SHCP) is described below.

### CaO-SHCP: Lime/Cement Production Incorporating SHCP

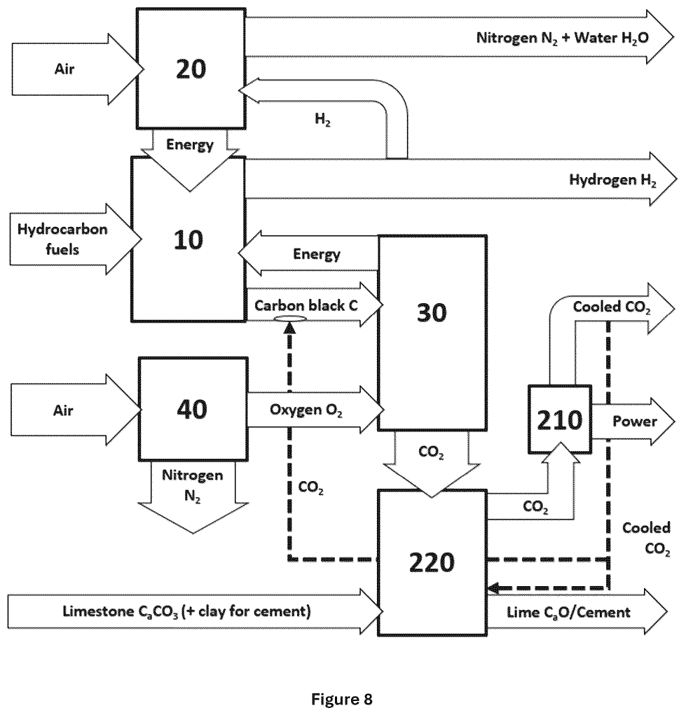

FIG. 8 is a schematic representation of an embodiment of lime/cement production process incorporating split hydrocarbon processing (CaO-SHCP).

Lime (CaO) and cement are produced from limestone (CaCO₃) calcination in CO₂ environment at 900° C. to 1050° C. emitting a nearly pure CO₂ stream.

The chemical reaction is:

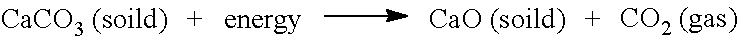

Referring to FIG. 8, hydrocarbon fuels are fed into split hydrocarbon processing (SHCP) unit 10 where decomposition of the carbon and hydrogen components takes place. The resulting products are separated into two streams: hydrogen (H₂) and solid carbon (carbon black C).

Hydrogen (H₂) can be exported and/or further processed through an air-fired combustion processing unit 20 to supply energy, resulting in the release of nitrogen and water. The hydrogen H₂ is an exported product, and part of it can be used to energize the split hydrocarbon processing unit 10 if needed.

The carbon black C from the split hydrocarbon processing unit 10 is fed to an oxy-fired combustion processing unit 30. Oxygen is pre-separated from nitrogen using an air separation unit (ASU) 40 and is also fed into the oxy-fired combustion processing unit 30. This oxy-fired combustion processing unit 30 produces the energy required for split hydrocarbon processing unit 10 and a high temperature CO₂ stream meeting the heat requirement of limestone calcination and the CO₂ stream is combined with that of the calcination which takes place in a calcination processing unit 220. After exiting the calcination processing unit 220, the CO₂ stream is used to drive a power cycle unit 210 to generate electricity while undergoing cooling. A portion of the cooled CO₂ is recycled to cool the lime/cement product while entering the calcination processing unit 220 for moderating the required calcination temperature. Another portion of the cooled CO₂ is recycled to convey the carbon black to the oxy-fired combustion processing unit 30. The rest of the cooled CO₂ is ready for compression and storage or utilization.

Although the present invention has been described in considerable detail with reference to certain preferred embodiments thereof, other embodiments and modifications are possible. Therefore, the scope of the appended claims should not be limited by the preferred embodiments set forth in the examples but should be given the broadest interpretation consistent with the description as a whole.

1. An application of split hydrocarbon processing (SHCP) to high pressure oxy-fired once through steam generation process (HiPrOx-OTSG-SHCP) for steam-assisted gravity drainage (SAGD) process, wherein:
hydrocarbon fuel is fed into a split hydrocarbon processing (SHCP) unit where decomposition of the carbon and hydrogen components takes place and the resulting products are separated into hydrogen and carbon black C,
the hydrogen is further processed through an air-fired combustion processing unit to supply energy, resulting in the release of nitrogen and water, or exported as a product,
the carbon black is fed to a high pressure oxy-fired combustion once through steam generation process unit as fuel to supply energy for the split hydrocarbon processing (SHCP) unit while indirectly produces steam for steam assisted gravity drainage (SAGD) process from cleaned SAGD recycled process water (PW) and fresh make up water,
the high pressure flue gas containing steam and CO₂ further indirectly produces steam through heat recovery steam generation for a power cycle to produce electricity, and
the condensed H₂O and gaseous CO₂ are separated with the water being recycled for slurring the carbon black while a fraction of the CO₂ is recirculated for flame moderation with the balance being ready for CO₂ compression and storage or utilization.

2. An application of split hydrocarbon processing (SHCP) to high pressure oxy-fired direct contact steam generation (HiPrOx-DCSG-SHCP) for steam-assisted gravity drainage (SAGD) process, wherein:
hydrocarbon fuel is fed into a split hydrocarbon processing (SHCP) unit where decomposition of the carbon and hydrogen components takes place and the resulting products are separated into hydrogen and carbon black C,
the hydrogen is further processed through an air-fired combustion processing unit to supply energy, resulting in the release of nitrogen and water, or exported as a product,
the carbon black is fed to a high pressure oxy-fired direct contact steam generation (HiPrOx-DCSG) process as fuel to supply energy for the split hydrocarbon processing (SHCP) while directly produce a high pressure mixture of steam and CO₂ for steam assisted gravity drainage (SADG) process from the untreated SADG recycled process water (PW) and fresh makeup water,
the high pressure mixture of steam and CO₂ are directly injected in steam assisted gravity drainage (SADG) wells, or the steam H₂O can be separated by condensing the steam to water and re-boiling the water to steam for steam assisted gravity drainage (SADG) wells, leaving the CO₂ for compression and storage or utilization after remaining moisture is condensed, and
the condensed H₂O is recycled for conveying carbon black.

3. An application of split hydrocarbon processing (SHCP) to gas turbine combined cycle (GTCC-SHCP) process, wherein:
hydrocarbon fuel is fed into a split hydrocarbon processing (SHCP) unit where decomposition of the carbon and hydrogen components takes place and the resulting products are separated into hydrogen and carbon black C,
the hydrogen is further processed through an air-fired combustion processing unit to supply energy, resulting in the release of nitrogen and water, or exported as a product,
a portion of the carbon black is fed to a high pressure oxy-fired gasification processing unit to supply energy for the split hydrocarbon processing (SHCP) while produce a CO stream and indirectly generate steam for steam power cycle to produce power,
the rest of the carbon black C is fed to a high pressure oxy-fired combustion processing unit to supply energy for the split hydrocarbon processing (SHCP) while produce a CO₂ stream driving a gas turbine for power generation,
the CO₂ stream after expansion is cooled by the feedwater of steam cycle and compressed to the pressure of the CO stream from the gasification process,
part of the CO₂ stream is recycled to high pressure oxy-fired combustion for temperature moderation, and
the rest of the CO₂ stream is mixed with the CO stream for deoxygenation, then is liquefied by the condensed water of steam cycle for compression and storage or utilization, and
a portion of the liquefied CO₂ stream is recycled for conveying carbon black.

4. An application of split hydrocarbon processing (SHCP) to Allam Cycle (Allam-SHCP), wherein:
hydrocarbon fuel is fed into a split hydrocarbon processing (SHCP) unit where decomposition of the carbon and hydrogen components takes place and the resulting products are separated into hydrogen and carbon black C,
the hydrogen is further processed through an air-fired combustion processing unit to supply energy, resulting in the release of nitrogen and water, or exported as a product,
the carbon black is fed to a high pressure oxy-fired combustion processing unit to supply energy for the split hydrocarbon processing (SHCP) while produce a high pressure and high temperature CO₂ stream to drive a gas turbine for power generation,
after expansion the exhaust CO₂ is cooled and a portion of it is recycled back through compression to the high pressure oxy-fired combustion processing unit for moderating the combustion flame temperature and conveying carbon black, and
the rest of the exhaust CO₂ cooled and ready for compression and storage or utilization, and
slurry processing to convey the carbon black C with liquefied CO₂ to the high pressure oxy-fired combustion processing unit employs a flash tank to depressurize the liquefied CO₂ at room temperature, to achieve chilly gaseous CO₂ and chilly liquid CO₂, the chilly gaseous CO₂ then transports the carbon black C to a slurry tank, where it mixes with the chilly liquid CO₂ to produce a chilly CO₂ and carbon C slurry.

5. An application of split hydrocarbon processing (SHCP) to hydrogen production for clean fuel process (H₂-SHCP), wherein:
hydrocarbon fuel is fed into a split hydrocarbon processing (SHCP) unit where decomposition of the carbon and hydrogen components takes place and the resulting products are separated into hydrogen and carbon black C,
the hydrogen is further processed through an air-fired combustion processing unit to supply energy, resulting in the release of nitrogen and water, or exported as a product,
the carbon black is fed to a high pressure oxy-fired gasification followed by a high temperature shift reaction slightly exothermic and provides sufficient heat to maintain within the optimal range of 700-800° C.,
the shifted gas is cooled through heat recovery network to remove H₂O for reuse of making carbon C slurry,
hydrogen is separated using a pressure swing adsorption (PSA) unit for export, and
a portion of the off-gas from pressure swing adsorption is sent through an amine stripper to remove CO₂ and the remaining CO rich gas is then recycled back to the shift processing through compression, and
the remaining off-gas from the pressure swing adsorption and the amine stripper undergoes CO oxy-fired combustion processing to supply energy for the split hydrocarbon processing (SHCP) and the amine stripper.

6. An application of split hydrocarbon processing (SHCP) to lime or cement production process (CaO-SHCP), wherein:
hydrocarbon fuel is fed into a split hydrocarbon processing (SHCP) unit where decomposition of the carbon and hydrogen components takes place and the resulting products are separated into hydrogen and carbon black C,
the hydrogen is further processed through an air-fired combustion processing unit to supply energy, resulting in the release of nitrogen and water, or exported as a product,
the carbon black is fed to an oxy-fired combustion process unit to supply energy for the split hydrocarbon processing (SHCP) while produce a high temperature CO₂ stream meeting the heat requirement of calcination reaction of limestone,
the CO₂ stream is combined with a second CO₂ stream produced from a calcination reaction in a calcination processing unit,
after exiting the calcination, the combined CO₂ stream is used to drive a power cycle to generate electricity while undergoes cooling,
a portion of the cooled CO₂ is recycled to cool the lime or cement product and back to the calcination reaction for moderating the required calcination temperature, and
another portion of the cooled CO₂ is recycled to convey carbon black, and
the rest of the cooled CO₂ is ready for compression and storage or utilization.
